(19) United States
(12) Patent Application Publication
(10) Pub. No.: US 2006/0004791 A1
(43) Pub. Date: Jan. 5, 2006

(54) Use of pseudo keys in node ID range based storage architecture

(76) Inventors: James C. Kleewein, San Jose, CA (US); Edison Lao Ting, San Jose, CA (US)

Correspondence Address: LACASSE & ASSOCIATES, LLC, 1725 DUKE STREET, SUITE 650, ALEXANDRIA, VA, 22314, US

(21) Appl. No.: 10/870,923

(22) Filed: Jun. 21, 2004

(51) Int. Cl. G06F 17/00

(52) U.S. Cl. 707/100

(57) ABSTRACT

A method of computing pseudo keys facilitates the bounding of node ID ranges. Pseudo keys are computed to facilitate node location in node ID ranges that have been split. A pseudo previous high key is computed by decrementing the last digit of the lowest node ID value in a newly formed node ID range by one and by appending ‘x’.‘x’. A computed pseudo key has no previous siblings or descendants of previous sibling having a node ID higher in value than a computed pseudo previous high key. Pseudo keys are also computed to define boundaries of a sub-tree. The range determined by a pseudo previous high key for a highest valued root node and a pseudo sub-tree high key bounds a sub-tree. Sub-tree pseudo keys are also comprised of a pseudo sub-tree low key and a pseudo end of document key.

### RELATED APPLICATIONS

This application is related to the application entitled “Extensible Decimal Identification System for Ordered Nodes”, now U.S. Ser. No. 10/605,448, and co-pending application entitled, “Hierarchical Storage Architectures using Node ID Ranges” both of which are hereby incorporated by reference in their entirety, including any appendices and references thereto.

### BACKGROUND OF THE INVENTION

1. Field of the Invention

The present invention relates generally to the field of node identifiers for hierarchical structures. More specifically, the present invention is related to the computation of pseudo keys for node identifiers.

2. Discussion of Prior Art

The hierarchy of a structured document, such as an XML document, is often represented by nodes in a logical tree. Correspondingly, nodes stored in storage units referred to as blocks provide a physical representation of a structured document. Each node in a tree is assigned and identified by a unique node identifier (ID). Sets of nodes stored in blocks form node ID ranges. A node ID range indicates the location of logical nodes within physical blocks. While a node may be logically proximate or adjacent to another node in a tree, it is not necessarily stored in the same or even proximate physical block.

Index entries in a node ID range index describe the ranges of node IDs that exist for nodes in a given block. For each node ID range in a block, an index entry is created. An index entry contains a field for a high node ID as well as a field indicating the block containing the specified range. A high node ID indicates the highest node ID in a specified node ID range. While node traversals within node ID ranges are accomplished via physical links, node traversals across ranges are facilitated via node ID range index lookups using a destination node ID.

In storage architectures utilizing node ID ranges to describe their contents, node insertions and updates often require the splitting as well as the merging of pre-existing node ID ranges. Insertions to node hierarchy only affect node ID ranges in which nodes are to be inserted because logical links are maintained between ranges. However, in some embodiments, insertions and deletions of nodes in a tree hierarchy necessitate the splitting of node ID ranges. A split node ID range further necessitates an additional index entry into a node ID range index. Keys for these new entries are found by traversing the nodes of the original node range and applying rules when finding the keys for the new index entry.

Whatever the precise merits, features, and advantages of the above cited references, none of them achieves or fulfills the purposes of the present invention. Therefore, there is a need in the art to compute keys to define node ID ranges without necessitating the traversal of an original node ID range.

### SUMMARY OF THE INVENTION

A system and method of the present invention provide for the determination of pseudo keys to facilitate the bounding of node ID ranges. A pseudo previous high key is computed by decrementing the last digit of the lowest node ID value in a split-formed node ID range by one and by appending ‘x’.‘x’, where ‘x’ represents an arbitrary value greater than any digit used in a node ID. Conversely, zero is used to represent an arbitrary value less than any digit used in a node ID. A pseudo previous high key is computed such that no previous siblings or descendants of previous sibling will have a node ID higher in value.

In a first embodiment, pseudo keys are computed for use in node ID ranges that have been split. The determination of a high node ID value for a split node ID range is facilitated by the use of pseudo keys. The need to search for a real previous high key is obviated by the computation of a pseudo previous high key. Additionally, the computation of a pseudo key lessens the logic necessary for node ID splits, and lessens the number of node ID index entries created during subsequent node insertions and deletions.

In a second embodiment, pseudo keys are used to define boundaries of a sub-tree. A sub-tree is bounded by the range determined by a pseudo previous high key for its root node and a pseudo sub-tree high key. A pseudo sub-tree high key is computed by appending ‘x’ to a sub-root node ID. A pseudo sub-tree high key is ordered higher than any node ID in a sub-tree having as root, a given node ID. That is, node IDs assigned to currently existing or newly inserted nodes in a sub-tree rooted at the specified node, including that of the specified node itself, are contained within a determined boundary. A pseudo sub-tree low key is computed by appending zero followed by one to a node ID. A pseudo sub-tree low key is ordered lower than any node ID in a sub-tree having as root, the specified node. A pseudo end of document key is given by the value of ‘x’, where ‘x’ again represents an arbitrary value greater than any digit used in a node ID. A pseudo end of document key is ordered higher than node IDs of other nodes in a structured document.

In a third embodiment, a plurality of dimensioned node IDs are formed by appending more than one ‘x’ to a node ID. Thus, the collation of persistent versioned nodes that order either higher than or lower than existing sibling nodes is allowed.

### BRIEF DESCRIPTION OF THE DRAWINGS

FIG. 1 illustrates a logical tree representation of ordered nodes in an XML document.

FIG. 2 illustrates multiple node ID ranges in a single logical XML tree.

FIG. 3 illustrates node ID range index entries corresponding to physical blocks.

FIG. 4a illustrates a single node ID range in a logical XML tree, associated node ID range index entry, and corresponding physical block.

FIG. 4b illustrates a split node ID range, node ID range index entries containing real keys, and corresponding physical blocks.

FIG. 4c illustrates a second split in node ID range, node ID range index entries containing real keys, and corresponding physical blocks.

FIG. 4d illustrates a split node ID range, node ID range index entries containing pseudo keys, and corresponding physical blocks.

FIG. 4e illustrates a second split in node ID range, node ID range index entries containing pseudo keys, and corresponding physical blocks.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

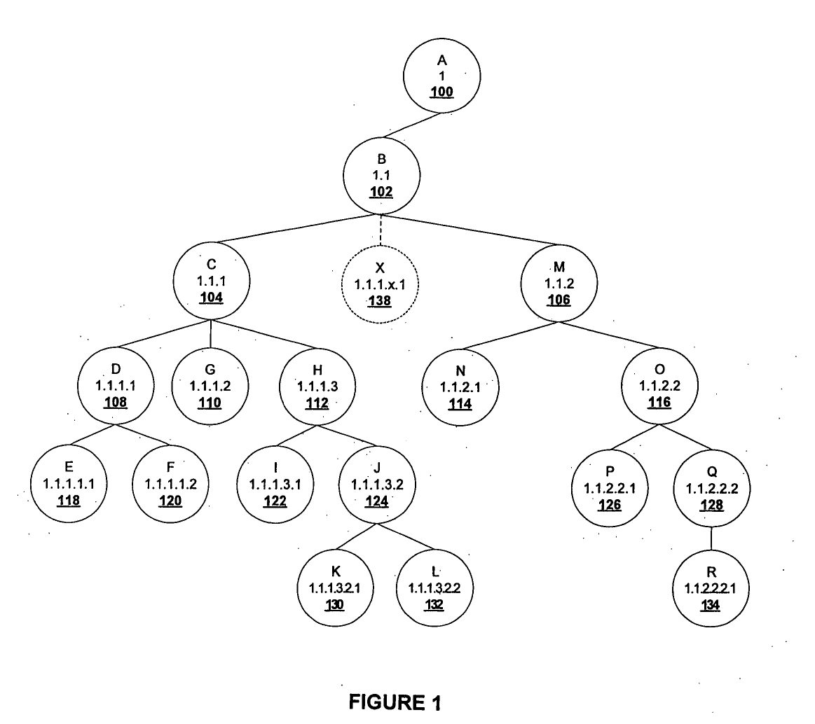

Shown in FIG. 1 is a tree representation of a structured document. Ordered nodes in the exemplary tree logically represent the hierarchy of a structured document, such as an XML document. Nodes stored in storage units referred to as blocks physically represent a structured document. Each node in a tree is identified by a unique node ID; for example, node C 104 has a node ID of 1.1.1. Node IDs are ordered in manner similar to a preorder traversal. Specifically, a node ID of 1.1.1.1 is less than a node ID of 1.1.1.1.1, which is less than a node ID of 1.1.1.1.2. Node IDs encode parent-child relationships. For example, node B 102 has a node ID of 1.1, and node C 104, as the first child of node B 102, has a node ID of 1.1.1. Node M 106, as a second child of node B 102, has a node ID of 1.1.2. The rightmost digit of a node ID encoding increases from sibling nodes on the left to sibling nodes on the right. Thus, node C 104, leftmost child of node B 102, has a node ID smaller than node M 106, rightmost child of node B 102.

Node IDs are generated based steps discussed in patent application commonly assigned U.S. Ser. No. 10/605,448 referenced in the background section. In accordance with one embodiment of this method, nodes inserted between siblings have more digits than previous or next siblings. A node X 138 inserted between node C 104 and node M 106 has a node ID value of 1.1.1.x.1, where ‘x’ represents an arbitrary value greater than any digit used in a node ID. Node X 138 having a node ID value of 1.1.1.x.1 ensures that descendants of node C 104 are not greater in value than nor ordered ahead of inserted node X 138. This is because descendants of node C 104 have node IDs generated such that their last digit does not reach the value of ‘x’.

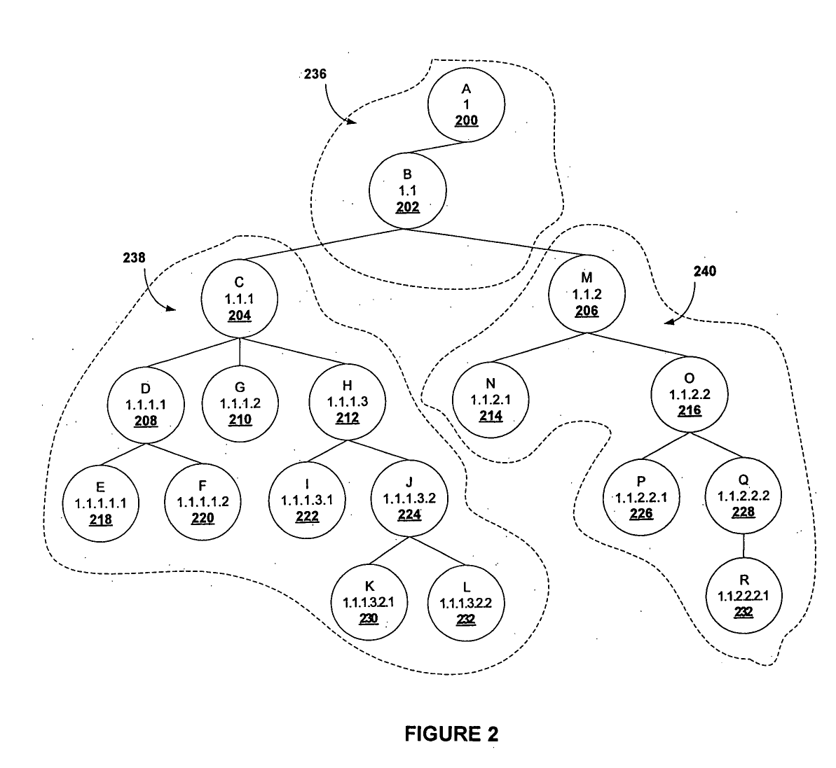

Nodes are stored in blocks based on a method as described in co-pending application “Hierarchical Storage Architectures for Node ID Ranges”. Sets of nodes stored in blocks form node ID Ranges. Shown in FIG. 2, is a separation of logical nodes into physical blocks. A first block 236 containing node A 200 and node B 202 is formed by a first range from node ID value 1 to node ID value 1.1. A second block 238 containing node C 204 through node L 232 is formed of node ID ranges from 1.1.1 to 1.1.1.3.2.2. A third block 240 containing node M 206 through node R 232 is formed by a third range of node ID values from 1.1.2 to 1.1.2.2.2.1. While a node may be logically proximate or adjacent to another node in a tree, for example, node C 204 and node M 206, it is not necessary for nodes C and M 204, 206 to be stored in the same block, or even proximate blocks.

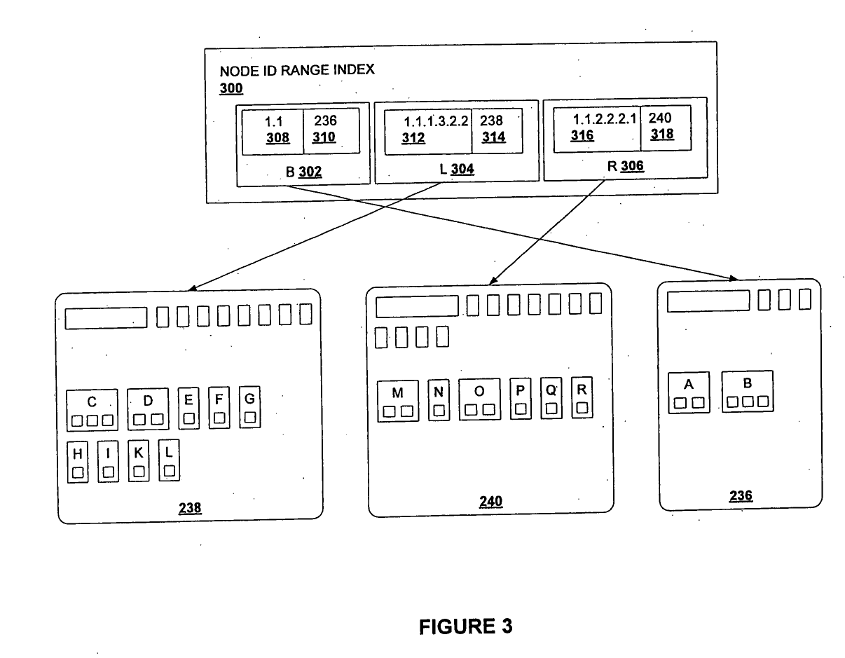

Shown in FIG. 3 is a node ID range index 300 for exemplary node ranges shown in FIG. 2. Index entries in a Node ID range index describe the ranges of node IDs that exist for a document in a given block. Node ID range indices are ordered by increasing value of node ID. For each node range in a block, a node ID range entry 302, 304, 306 is created. Node ID range entries 302, 304, 306 contain fields for high node ID 308, 312, 316 in as well as fields indicating the block containing node ID range 310, 314, 318. A high node ID 308, 312, 316 indicates the highest node ID in a specified node ID range. A node having a high node ID is also referred to as an indexed node, meaning that a node ID range index entry is created for it. Node ID range entry 302 corresponds to the node range from node A 200 to node B 202. Node ID range entry 304 corresponds to the node range from node C 204 to node L 232. Node ID range entry 306 corresponds to the node range from node M 206 to node R 232. In FIG. 3, high node ID 308, 312, 316 for each range is also high node IDs for each corresponding block 236, 238, 240. In other embodiments, a high node ID for a node ID range is not the high node ID for a block.

Node traversals within node ID ranges are accomplished via physical links while node traversals across ranges are accomplished via node ID range index 300 lookups based on a current node ID. For example, in order to traverse node B 202 to node C 204, a node ID range index 300 lookup using the node ID value 1.1.1 of destination node C 204 is performed. A lookup operation using node C 204 results in the use of node ID range index entry 304 having as the value of its high node ID 312, 1.1.1.3.2.2. Insertions to node hierarchy only affect ranges in which nodes are to be inserted because logical links are maintained between ranges. In some embodiments, insertions and deletions of nodes in a tree hierarchy necessitate the splitting of node ID ranges. A split node ID range further necessitates an additional node ID range index entry into node ID range index 300. High node ID values for new node ID range index entries are obtained by traversing nodes of an original node range and subsequently applying rules to traversed nodes IDs. For a detailed discussion of these rules, please refer to co-pending application, “Hierarchical Storage Architectures for Node ID Ranges”.

The determination of a high node ID value for a node ID range is facilitated by the use of pseudo keys. Rather than simply selecting as a high node ID the highest node ID value in a node ID range, a pseudo key is computed. The computation of a pseudo key lessens the logic necessary for node ID splits, and lessens the number of node ID index entries created during subsequent insertions and deletions. In a first embodiment, pseudo keys are computed for use in node ID ranges that have been split.

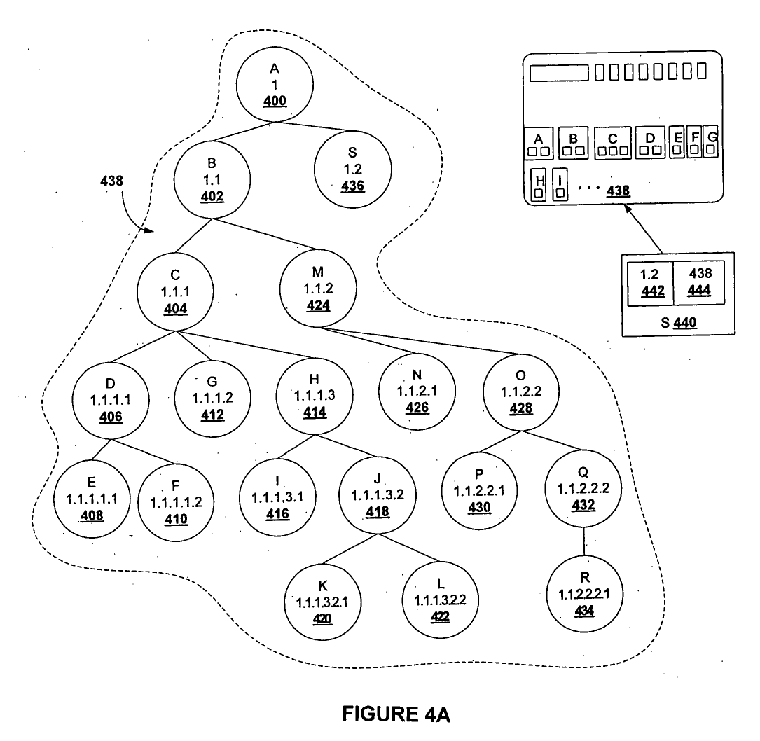

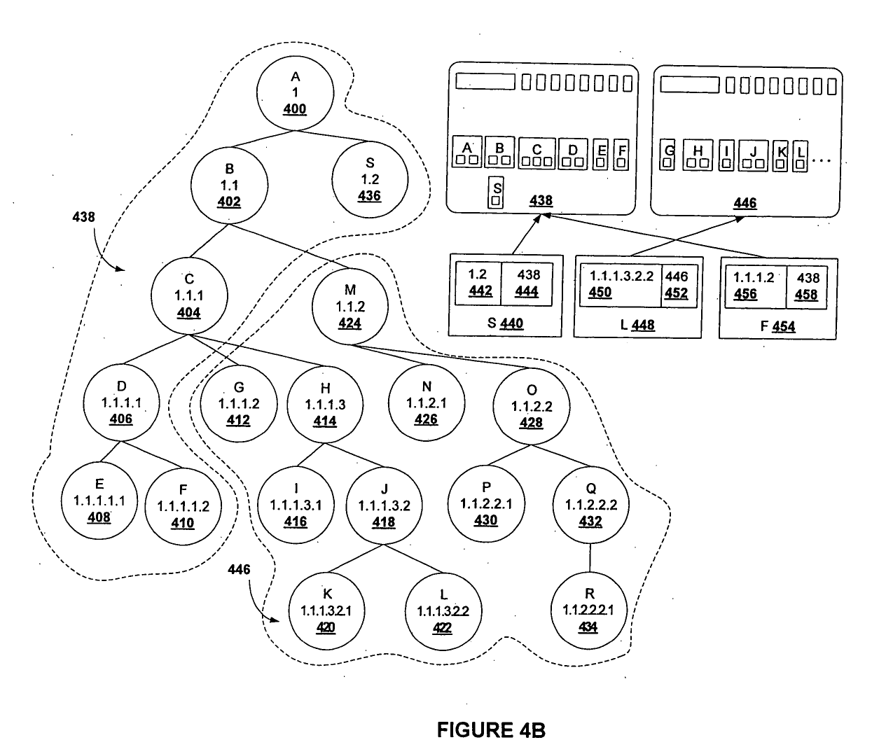

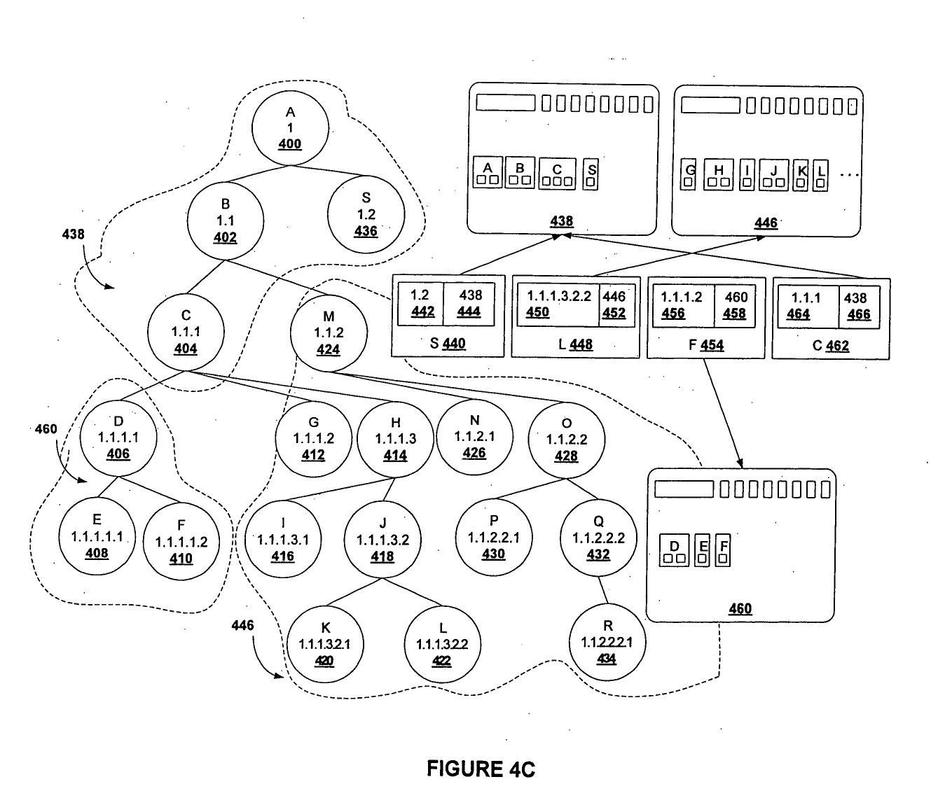

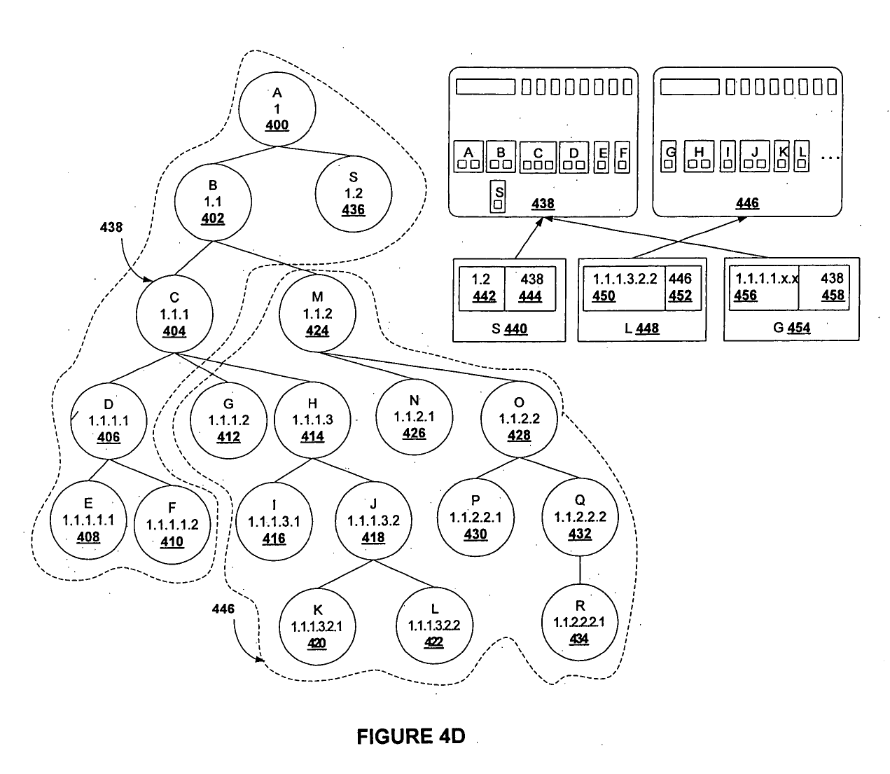

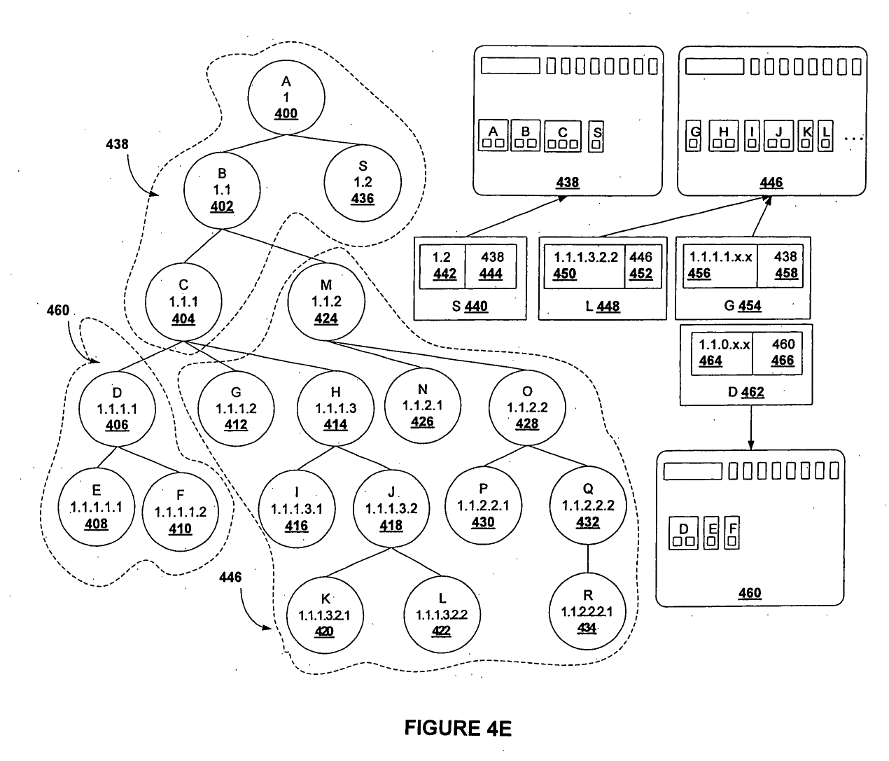

FIG. 4a illustrates an initial stage of storage in which nodes are stored in a single block 438. The highest node ID in a block is known as a range high key. If a node is to be inserted into block 438, it is first determined if node ID assigned to a node to be inserted is less than a range high key for block 438. In FIG. 4a, range high key is node S 436 having a node ID of 1.2. Thus, a node ID range index entry 440 for the exemplary tree has as its high ID node field 442 the value of 1.2 and as its corresponding block field 444, block 438.

In FIG. 4b a node ID range split in shown. Nodes are now stored two blocks 438 and 446. However, the ranges of node IDs stored in first block 438 are no longer contiguous. First block 438 is now shown contain two exemplary node ID ranges; one range from node A 400 to node F 410, and another range from node M 424 to node S 436. If an insertion is made after a node ID range split, it is necessary to know a high key for new ranges created by node ID range split. The high node ID in block 438 remains high node key S 436 for a given range. However, in block 446, range high key is now node L 422 having a node ID of 1.1.1.3.2.2. A new node ID range index entry 448 for node L 422 is created. Node ID range index entry 448 has as its high node ID field 450 1.1.1.3.2.2 and as its corresponding block field 452, block 446. To provide for arbitrary insertions of nodes, it also necessary to know the high key of adjacent range created by node ID range split. This node is known as a previous high key. In FIG. 4b, node F 410 having a node ID of 1.1.1.1.2 is determined to high key of adjacent range, thus is known as a previous high key. Without computing a pseudo key, it is necessary to find a previous high key and insert into node ID range index an entry 454 containing said previous high key. In the exemplary figure, previous high key to newly formed node ID range is node F 410 having a node ID of 1.1.1.1.2. A node ID range index entry containing for node F 410 containing previous high key 1.1.1.1.2 corresponding to first block 438 is inserted into node ID range index.

In FIG. 4c, another node ID range split in first block 438 contributes another node ID range to block 460. First block 438 now has node ID ranges from node A 400 to node C 404 and node S 436. Second block 446 has a node ID range remaining from node G 412 to node L 422. Newly formed third block 460 has a node ID range from node D 406 to node F 410. Because another range is formed in third block 460, it is necessary to find a previous high key for a new node ID range determined by third block 460 and to create and insert an entry in node ID range index. Because node D 406 does not have a previous sibling, immediate parent node C 404 having a node ID of 1.1.1 serves as a previous high key. An entry containing node ID 1.1.1 of node C 404 corresponding to first block 438 is created and inserted into a node ID range index.

In FIG. 4d, the need to search for a previous high key is obviated by the computation of a pseudo previous high key. The computation of a pseudo previous high key create reduces the frequency at which new node ID range index entries are created and inserted into a node ID range index. Using the method of the present invention, it is possible to compute a pseudo previous high key for node G 412 of second block 446 and insert a new node ID index entry containing pseudo previous high key for node G 412 into node ID range index. In FIGS. 4b and 4c, node G 412 has the lowest node ID value in a node ID range newly formed by a split. A pseudo previous high key is computed by decrementing the last digit of the lowest node ID value in a newly formed node ID range by one and by appending ‘x’.‘x’. As with the method of generating node IDs, ‘x’ represents an arbitrary value greater than any digit used in a node ID. Pseudo key computation ensures that there exist no previous siblings or descendants of previous sibling having a node ID higher in value than a computed pseudo previous high key. For example, a pseudo previous high key for node G 412 having a node ID of 1.1.1.2 is 1.1.1.1.x.x. Utilizing a pseudo previous high key eliminates the need for new node ID range index entries for subsequent insertions into a sub-tree having as root, node D 408. Meaning, if a real previous key is found instead, which in FIG. 4c is node F 410, it would be necessary to insert a new node ID range index entry into node ID range index each time a node is inserted as a descendant of node D 408.

In FIG. 4e, a pseudo previous high key for new node ID range determined by third bock 460 is computed. By computing a pseudo previous high key for node D 406, the need to find and index node C 404 is eliminated. Decrementing the last digit of node ID 1.1.1.1 assigned to node D 460 by one and appending ‘x’.‘x.’ produces a pseudo previous high key of node ID of 1.1.1.0.x.x.

In another embodiment, pseudo keys are used to define boundaries of a sub-tree. For example, a sub-tree having as root node H 414 as shown in FIG. 4e is bounded by the range determined by a pseudo previous high key for node H 414 and a pseudo sub-tree high key. A pseudo sub-tree high key is computed by appending ‘x’ to a highest valued sub-tree root node in a select set of nodes comprising a node ID range. A pseudo sub-tree high key is ordered higher than any node ID in a sub-tree and therefore, is ordered higher than any node ID in selected set of nodes. In the exemplary figure, a sub-tree having as root node H 414 is bounded by pseudo previous high key of 1.1.1.2.x.x and a pseudo sub-tree high key of 1.1.1.3.x. That is, node IDs assigned to currently existing or newly inserted nodes in a sub-tree rooted at node H 414, including that of node H 414, are contained within a determined boundary. A pseudo sub-tree low key is computed by appending zero followed by one to a lowest valued sub-tree root node in a select set of nodes comprising a node ID range. Thus, a pseudo sub-tree low key is ordered lower than any node ID in a selected set of nodes. For example, a pseudo sub-tree low key computed for a selected set of nodes, in this case, a sub-tree rooted at node ID of 4.4, is 4.4.0.1. Computed pseudo sub-tree low key is ordered lower than any node ID in a selected set, and thus ordered lower than any node ID in a sub-tree having as root, node ID 4.4. In one embodiment, a pseudo sub-tree low key is extended by adding more zeros before the appended one. For example, a pseudo sub-tree low key for a node ID of 4.4 is 4.4.0.0.0.1. A pseudo end of document key is given by the value of ‘x’. A pseudo end of document key is ordered higher than node IDs of other nodes in a structured document.

In yet another embodiment, a plurality of dimensioned pseudo keys are formed by appending more than one ‘x’ to existing node ID before appending a known digit. A known digit for a pseudo sub-tree low key is one. For example, a pseudo key for node ID 4.5 is also computed as 4.4.x.x.1, 4.4.x.x.x.1, and so on. Thus, a provision is made for the collation of persistent versioned nodes that order either higher than or lower than existing sibling nodes.

Additionally, the present invention provides for an article of manufacture comprising computer readable program code contained within implementing one or more modules to compute pseudo keys for existing node IDs, create index entries for computed pseudo keys, and insert index entries for computed pseudo keys. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) computing a pseudo key or pseudo keys for an existing node ID; (b) creating a node ID range index record; and (c) inserting into a node ID range index said created index entry.

### CONCLUSION

A system and method has been shown in the above embodiments for the effective implementation of psuedo keys in node ID range based storage architecture. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program or specific computing hardware.

The above enhancements are implemented in various computing environments. For example, the present invention may be implemented on a conventional IBM PC or equivalent. All programming and data related thereto are stored in computer memory, static or dynamic, and may be retrieved by the user in any of: conventional computer storage and/or display (i.e., CRT) formats. The programming of the present invention may be implemented by one of skill in the art object-oriented programming.

1. A method for defining node identifier (ID) ranges corresponding to nodes in a hierarchy comprising steps of determining a node ID value in a first node ID range of a storage unit and computing a pseudo key from said determined node ID to bound a second node ID range; said second node ID range facilitating node location within said first node ID range.

2. A method for defining node ID ranges, as per claim 1, wherein said hierarchy is derived from any of: a structured document, computer network, or file system directory hierarchy.

3. A method for defining node ID ranges, as per claim 1, wherein said first node ID range is comprised of one or more ordered node IDs obtained from said hierarchy.

4. A method for defining node ID ranges, as per claim 1, wherein said determined node ID value is any of: a lowest valued node ID in said first node ID range, a lowest valued sub-tree root node in said first node ID range, a highest valued sub-tree root node in said first node ID range, or a highest valued node ID in said first node ID range.

5. A method for defining node ID ranges, as per claim 1, wherein said pseudo key computed is any of: a pseudo previous high key, pseudo sub-tree high key, pseudo sub-tree low key, or a pseudo end of document key.

6. A method for defining node ID ranges, as per claim 2, wherein said structured document is an XML document.

7. A method for defining node ID ranges, as per claim 5, wherein said pseudo previous high key is computed by decreasing last digit of said determined node ID value and by appending two or more times in succession to said decreased node ID value, an arbitrary value greater than any digit comprising a node ID in said first node ID range.

8. A method for defining node ID ranges, as per claim 5, wherein said pseudo end of document key is determined by an arbitrary value greater than any digit comprising a node ID in said first node ID range.

9. A method for defining node ID ranges, as per claim 5, wherein said pseudo sub-tree high key is computed by appending one or more times in succession to said determined node ID value, an arbitrary value greater than any digit comprising a node ID in said first node ID range.

10. A method for defining node ID ranges, as per claim 5, wherein said pseudo sub-tree low key is computed by appending one or more times in succession to said determined node ID value, an arbitrary value less than any digit comprising a node ID in said first node ID range, followed in succession by a value of one.

11. A method for defining node ID ranges, as per claim 5, wherein said pseudo keys are used to define boundaries for a sub-tree in said first node ID range.

12. A method for defining node ID ranges, as per claim 7, wherein said determined node ID value is a lowest valued node ID in said first node ID range.

13. A method for defining node ID ranges, as per claim 8, wherein said node ID range is comprised of all ordered nodes in said hierarchy of nodes.

14. A method for defining node ID ranges, as per claim 9, wherein said determined node ID is a highest valued sub-tree root node in said first node ID range.

15. A method for defining node ID ranges, as per claim 10, wherein said determined node ID value is a lowest valued sub-tree root node in said first node ID range.

16. A method for defining node ID ranges, as per claim 11, wherein said boundaries for said sub-tree are determined by a pseudo previous high key and a pseudo sub-tree high key for said determined node ID value in said first node ID range.

17. A article of manufacture comprising computer usable medium having computer readable program code embodied therein which defines node identifier (ID) ranges corresponding to nodes in a hierarchy, said medium comprising computer readable program code determining a node ID value in a first node ID range of a storage unit and computer readable program code computing a pseudo key from said determined node ID to bound a second node ID range; said second node ID range facilitating node location within said first node ID range.

18. An article of manufacture, as per claim 17, wherein said determined node ID value is any of: a lowest valued node ID in said first node ID range, a lowest valued sub-tree root node in said first node ID range, a highest valued sub-tree root node in said first node ID range, or a highest valued node ID in said first node ID range.

19. An article of manufacture, as per claim 18, wherein said pseudo key computed is
a. a pseudo previous high key, if said determined node ID value is a lowest valued node ID in said first node ID range,
b. a pseudo sub-tree high key, if said determined node ID value is a highest valued sub-tree root node in said first node ID range,
c. a pseudo sub-tree low key, if said determined node ID value is a lowest valued sub-tree root node in said first node ID range, else a
d. pseudo end document key, if said determined node ID value is a highest valued node ID in said first node ID range.

20. An article of manufacture, as per claim 19, wherein
a. said pseudo previous high key is computed by decreasing last digit of said determined node ID value and by appending two or more times in succession to said decreased node ID value, an arbitrary value greater than any digit comprising a node ID in said first node ID range,
b. said pseudo end of document key is determined by an arbitrary value greater than any digit comprising a node ID in said first node ID range,
c. said pseudo sub-tree high key is computed by appending one or more times in succession to said determined node ID value, an arbitrary value greater than any digit comprising a node ID in said first node ID range, and
d. pseudo sub-tree low key is computed by appending one or more times in succession to said determined node ID value, an arbitrary value less than any digit comprising a node ID in said first node ID range, followed in succession by a value of one.

21. A system defining node ID ranges corresponding to nodes in a hierarchy comprising: a node ID value determined from a first node ID range of a storage unit and a pseudo key computed from said node ID value bounding a second node ID range; said second node ID range facilitating node location within said first node ID range.
